(19) United States
(12) Patent Application Publication
(10) Pub. No.: US 2007/0289414 A1
(43) Pub. Date: Dec. 20, 2007

(54) Ratchet mechanism for hand tools

(76) Inventor: Chang Chuan Lee, Nantou (TW)

Correspondence Address: CHANG CHUAN LEE, P.O. BOX 2103, TAICHUNG, omitted

(21) Appl. No.: 11/723,985

(22) Filed: Mar. 23, 2007

Related U.S. Application Data
(63) Continuation-in-part of application No. 11/455,832, filed on Jun. 20, 2006.

(51) Int. Cl. B25B 13/46

(52) U.S. Cl. 81/60

(57) ABSTRACT

A ratchet hand tool includes a handle and a head in which a through hole is defined there. A driving member is rotatably received in the through hole. A recess is defined in an inner periphery of the through hole and a ratchet mechanism is received in the recess. The ratchet mechanism includes a first member with a curved and smooth surface, a second member with teeth, and a spring member is connected between the first and second members. The teeth of the second member are engaged with the teeth in the driving member so that the teeth of the driving member that are in contact with the curved and smooth surface of the first member are not worn out during operation. Two ends of the spring member are retained in the first and second notches defined in the first and second members.

This is a Continuation-In-Part patent application of applicant's former patent application with application Ser. No. 11/455,832, filed on Jun. 20, 2006.

### FIELD OF THE INVENTION

### Background of the Invention

A conventional ratchet hand tool 6 such as a ratchet wrench is shown in FIG. 16 and generally includes handle 61 and a head 62 which includes a through hole 63 and a recess 64 defined in an inner periphery of the through hole 63. A driving member 7 is rotatably received in the through hole 63 and retained by a C-shaped clip 72. A ratchet mechanism 8 is received in the recess 64 and includes a first pawl 81 and a second pawl 82, a spring 83 has two ends thereof engaged with two respective protrusions 812, 833 extending from the two pawls 81, 82. Each of the first and second pawls 81, 82 has teeth 811/821 defined in a side thereof and the first pawl 81 or the second pawl 82 is engaged with teeth 71 defined in an outer periphery of the driving member 7 alternatively. When the first pawl 81 is engaged with the driving member 7, the driving member 7 is rotated with the handle 61 so as to output torque in a first direction. When the second pawl 82 is engaged with the driving member 7, the driving member 7 is rotated with the handle 61 so as to output torque in a second direction. However, it is noted that when the first pawl 81 is engaged with the driving member 7, the teeth 822 of the second pawl 82 are in contact with the teeth 71 of the driving member 7, so that the teeth 71 of the driving member 7 and the teeth 822 of the second pawl 82 wear out during rotating in the first direction, vice versa.

The present invention intends to provide a ratchet mechanism which includes two members and one of which includes a curved surface and the other one has teeth to be engaged with the driving member, so that during operation, the teeth of the driving member do not wear out by the member with the curved surface.

### SUMMARY OF THE INVENTION

The present invention relates to a ratchet hand tool that includes a handle and a head which has a through hole for receiving a driving member which has first teeth, and a recess is defined in an inner periphery of the through hole so as to receive a ratchet mechanism therein. The ratchet mechanism has a first member with a curved and smooth surface, a second member with second teeth, and a spring member connected between the first and second members. The second teeth are engaged with the first teeth. The first member has a first notch and the second member has a second notch. Two ends of the spring member are retained with the first and second notches.

The primary object of the present invention is to provide a ratchet mechanism for a hand tool and the mechanism includes a first member with a curved and smooth surface, a second member with teeth which are engaged with the driving member, and a spring connected between the first and second members. The teeth of the driving member are not worn out during operation because of the curved and smooth surface.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a ratchet hand tool of the present invention;

FIG. 2 is a cross sectional view to show the ratchet hand tool of the present invention;

FIG. 3 shows a second embodiment of the spring member of the ratchet mechanism;

FIG. 4 shows a third embodiment of the spring member of the ratchet mechanism;

FIG. 5 shows a fourth embodiment of the spring member of the ratchet mechanism;

FIG. 6 is an exploded view to show a second embodiment of the ratchet mechanism of the ratchet hand tool of the present invention;

FIG. 7 is a cross sectional view to show the ratchet hand tool of the present invention as shown in FIG. 6;

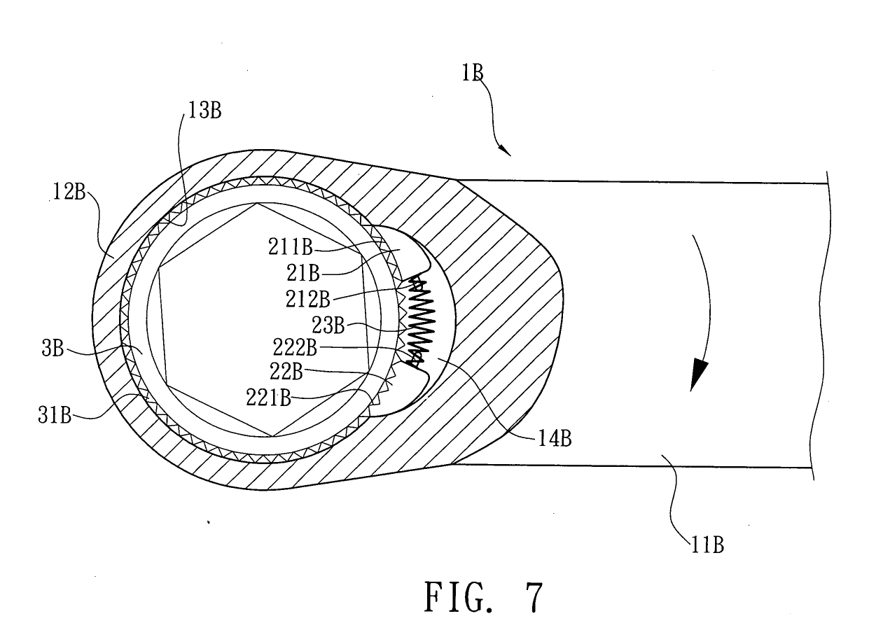

FIG. 8 shows a second embodiment of the spring member of the ratchet mechanism as shown in FIG. 6;

FIG. 9 is an exploded view to show a second embodiment of the ratchet tool of the present invention;

FIG. 10 is an exploded view to show a third embodiment of the ratchet mechanism of the ratchet hand tool of the present invention;

FIG. 10a shows the size of the first notch of the first member of the ratchet mechanism in FIG. 10;

FIG. 11 is a cross sectional view to show the ratchet hand tool of the present invention as shown in FIG. 10;

FIG. 12 is a top cross sectional view of the ratchet hand tool of the present invention as shown in FIG. 10;

FIG. 13 is a top cross sectional view to show the operation of the ratchet hand tool of the present invention as shown in FIG. 10;

FIG. 14 shows a second embodiment of the spring member of the ratchet mechanism as shown in FIG. 10;

FIG. 15 shows a third embodiment of the spring member of the ratchet mechanism as shown in FIG. 10, and

FIG. 16 shows an exploded view of a conventional ratchet tool.

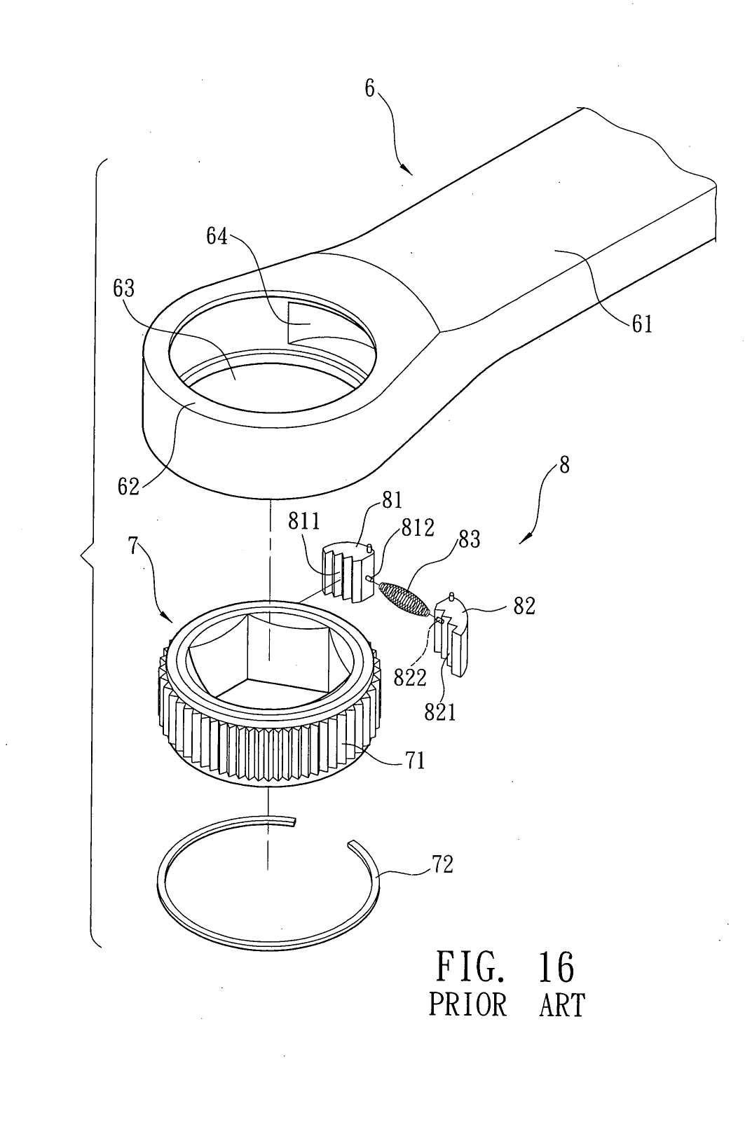

### DETAILED DESCRIPTION OF THE PREFERRED EMBODIMENT

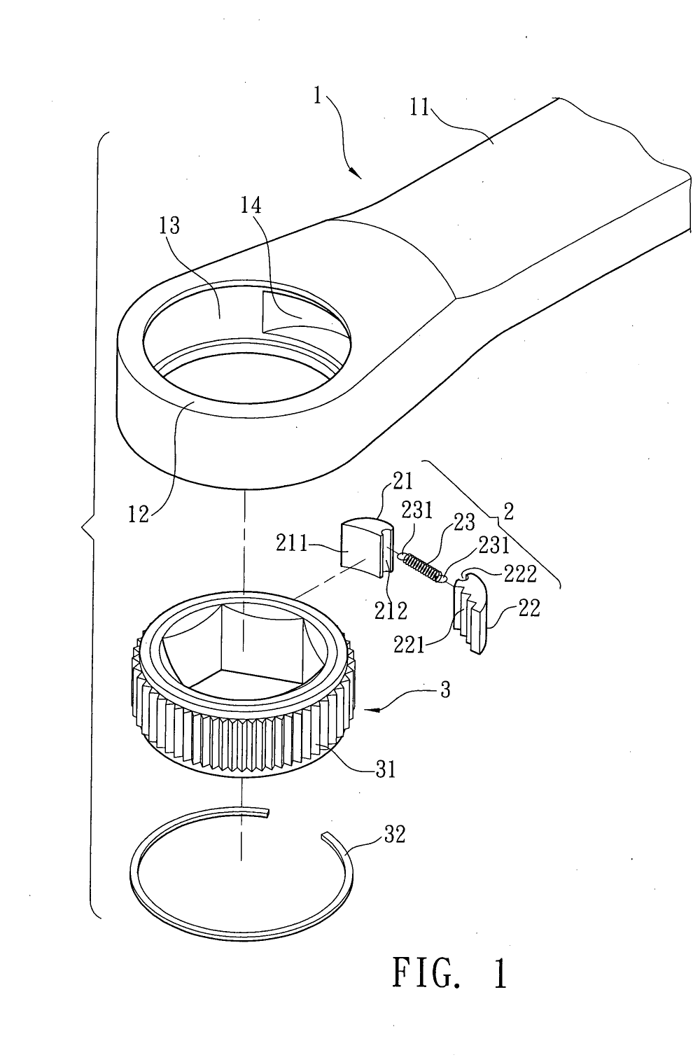

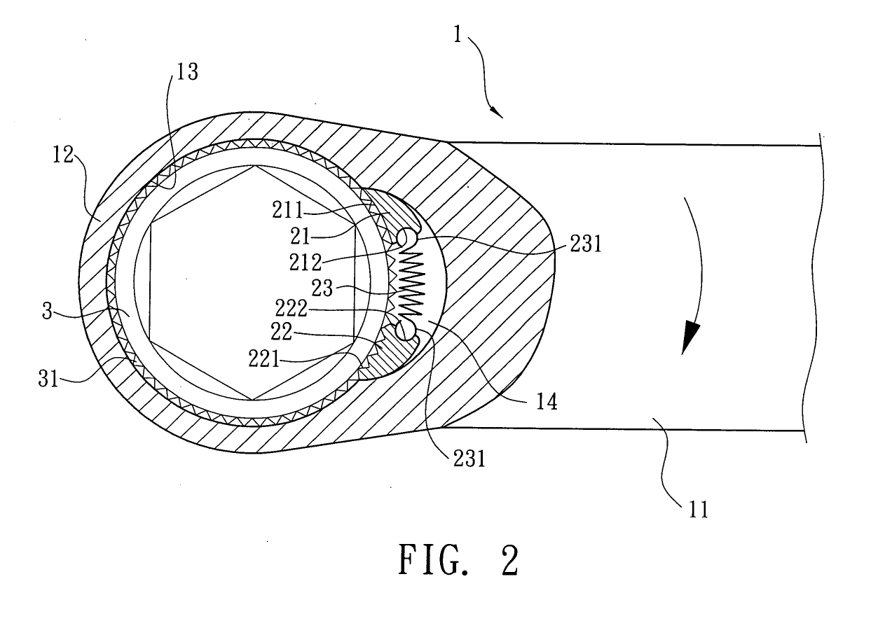

Referring to FIGS. 1 and 2, the ratchet hand tool 1 of the present invention comprises a handle 11 and a head 12 is connected to an end of the handle 11. A through hole 13 is defined in the head 12 and a recess 14 defined in an inner periphery of the through hole 13. A driving member 3 with first teeth 31 defined in an outer periphery thereof is rotatably received in the through hole 13 and retained by engaging a C-shaped clip 32 with the head 12. A ratchet mechanism 2 is received in the recess 14 and has a first member 21 with a curved and smooth surface 211 facing the driving member 3, a second member 22 with second teeth 221, and a spring member 23 connected between the first and second members 21, 22. The second teeth 221 are engaged with the first teeth 31 so that when rotating the handle 11, the driving member 3 is rotated with the rotation of the handle 11. The first member 21 has a first notch 212 defined in an end thereof and the second member 22 has a second notch 222 defined in an end thereof. Two ends of the spring member 23 are two rings which are engaged with the first and second notches 212, 222. The spring member 23 is a compression spring.

The first teeth 31 of the driving member 3 are engaged with the second teeth 221 of the second member 22, and curved and smooth surface 211 of the first member 21 does not cause any significant friction to the first teeth 31 so that the first teeth 31 are not worn out during operation. If the user wants to output a torque in opposite direction, the hand tool 1 is then flip over and engage the workpiece (not shown) again to output the torque.

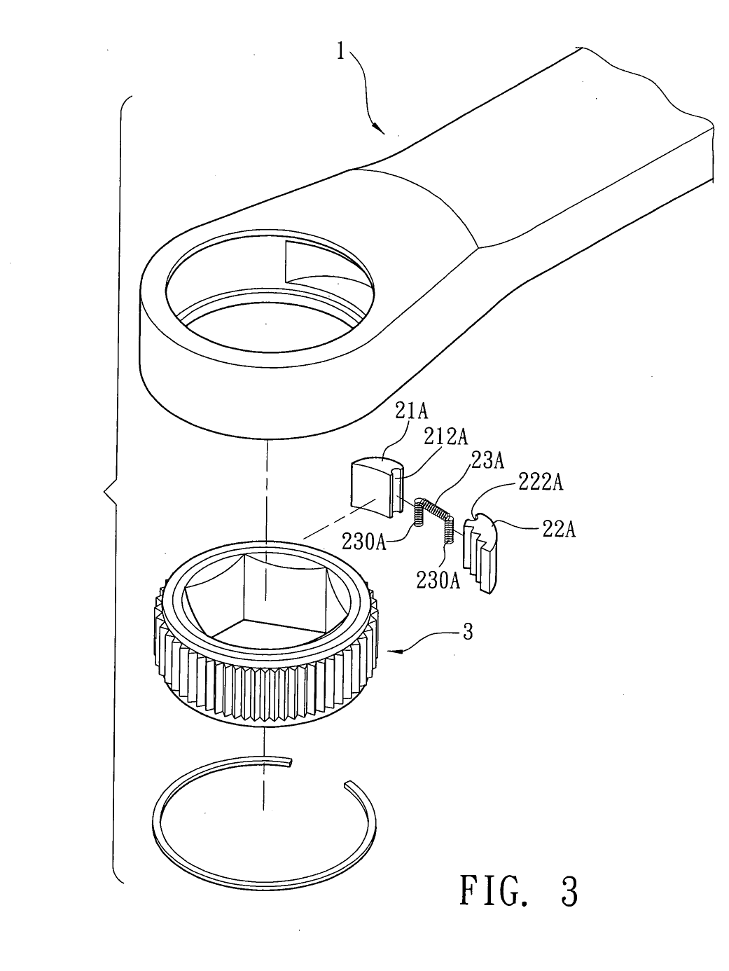

FIG. 3 shows that the spring member 23A can be an inverted U-shaped member and two ends 230A of the spring member 23A are engaged with the notches 212A of the first member 21A and the second notch 222A of the second member 22A.

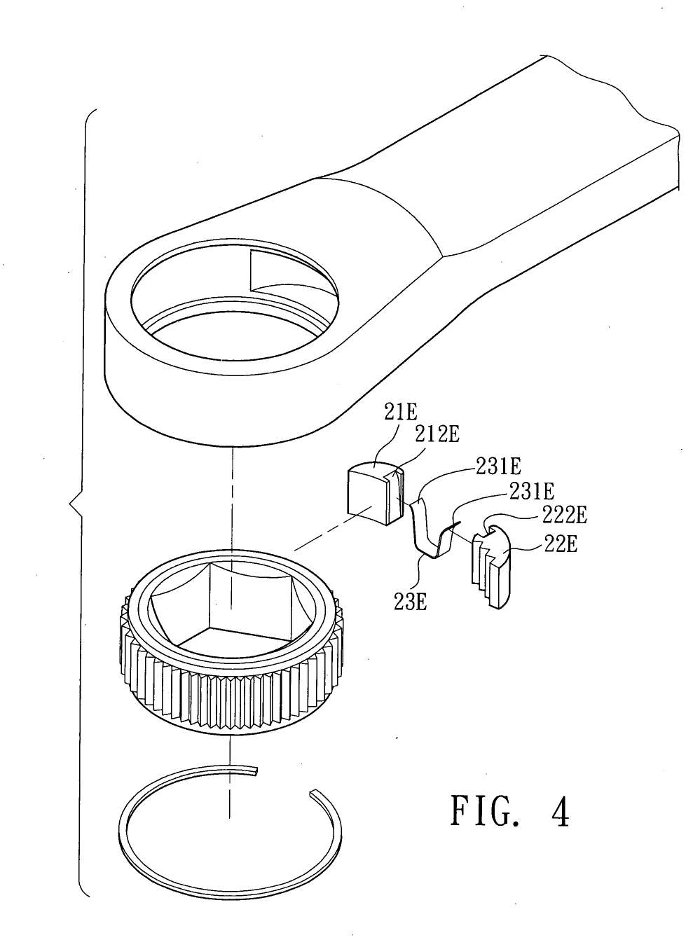

As shown in FIG. 4, the spring member 23E can be a U-shaped member and the two ends 231E of the spring member 23E are engaged with the first and second notches 212E, 222E of the first and second members 21E, 22E.

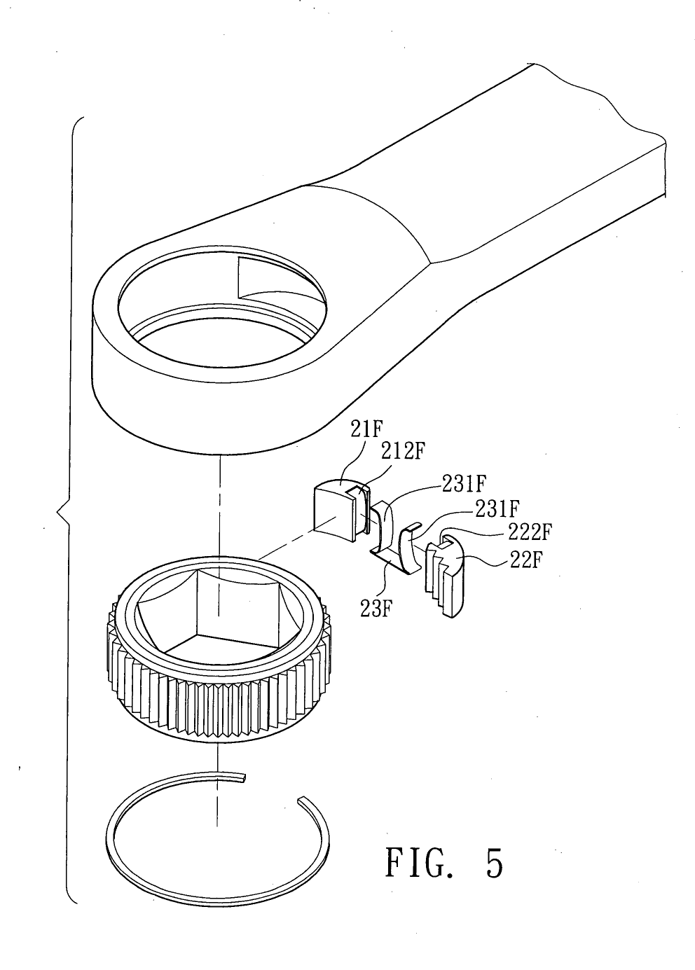

FIG. 5 shows that the spring member 23F can be a p-shaped member and the two ends 231F of the spring member 23F are engaged with the first and second notches 212F, 222F of the first and second members 21F, 22F.

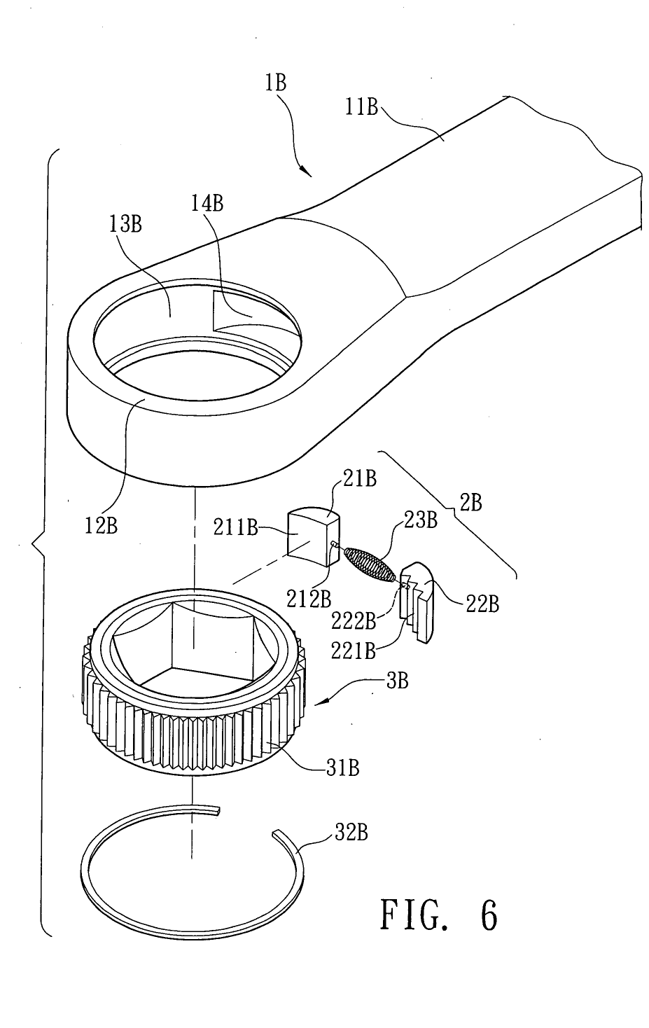

FIG. 6 shows a second embodiment of the ratchet mechanism 2B of the present invention and the ratchet mechanism 2B comprises a handle 11B and a head 12B is connected to an end of the handle 11B. A through hole 13B is defined in the head 12B and a recess 14B is defined in an inner periphery of the through hole 13B. A driving member 3B is rotatably received in the through hole 13B and retained by engaging a C-shaped clip 32B with the head 12B. The driving member 3B has first teeth 31B defined in an outer periphery thereof. The ratchet mechanism 2B is received in the recess 14B and has a first member 21B with a curved and smooth surface 211B which faces the driving member 3B, a second member 22B with second teeth 221B, and a spring member 23B connected between the first and second members 21B, 22B. The spring member 23B is a compression spring and the second teeth 221B are engaged with the first teeth 31B. The first member 21B has a first protrusion 212B and the second member 22B has a second protrusion 222B. Two ends of the spring member 23B are engaged with the first and second protrusions 212B, 222B.

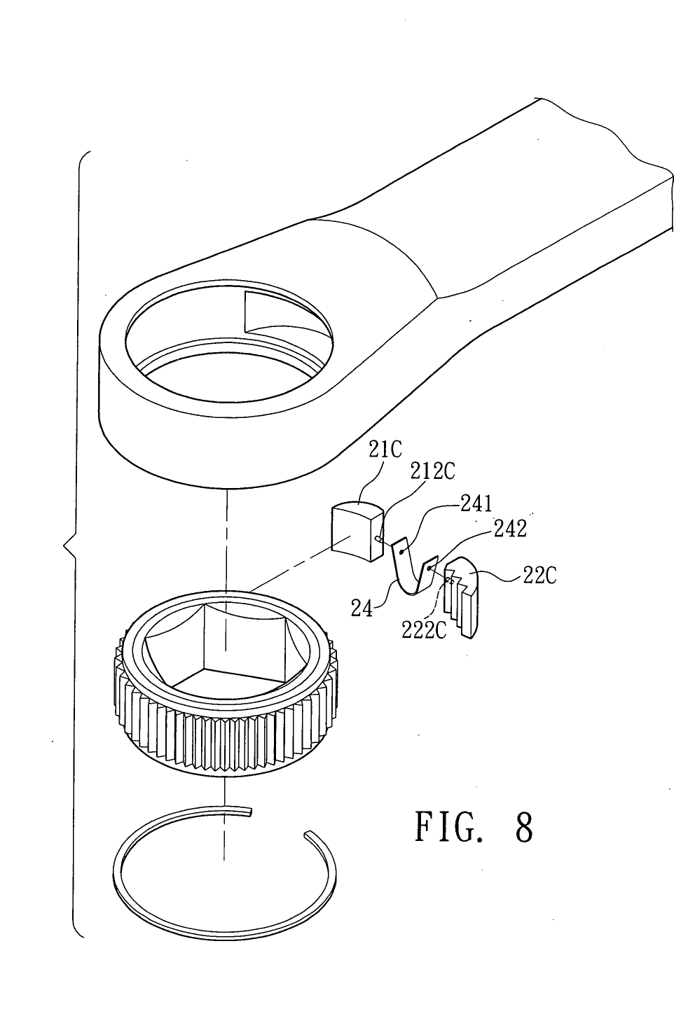

As shown in FIG. 8, the spring member 24 is a spring plate which has two holes 241 defined in two ends thereof. Each of the first and second members 21C, 22C has a protrusion 212C/222C. The two protrusions 212C and 222C are engaged with the two holes 241 of the spring member 24.

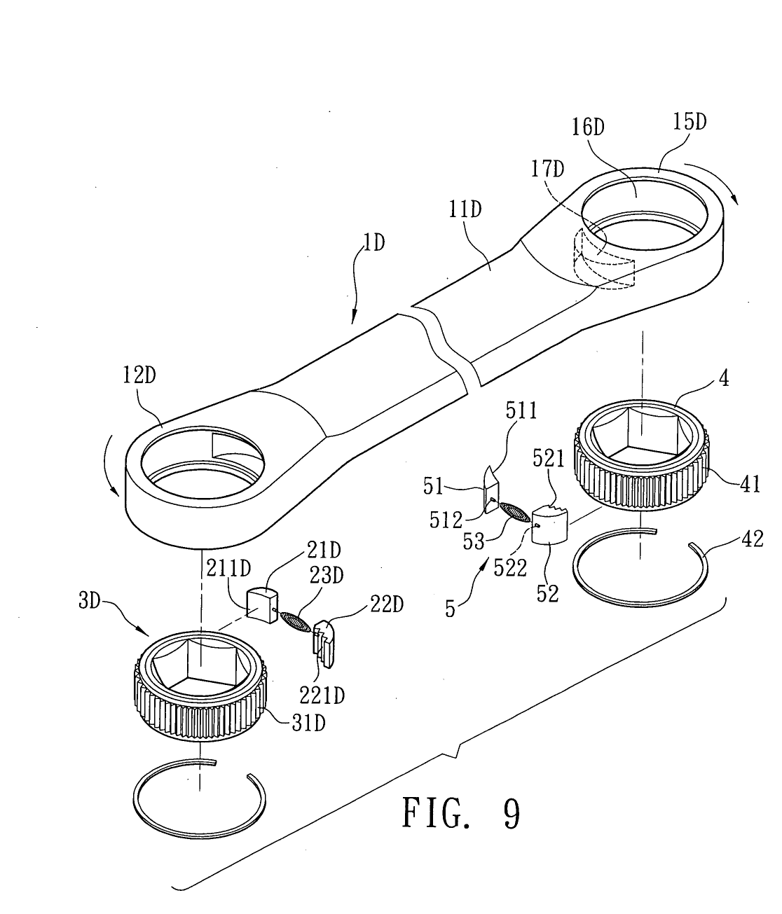

FIG. 9 shows a second embodiment of the ratchet hand tool wherein a first head 12D and a second head 15D are connected to two ends of the handle 11D. The first head 12D has a through hole for receiving a driving member 3D with teeth 31D in outer periphery thereof and a ratchet mechanism is received in a recess defined in an inner periphery of the through hole in the first head 12D. The ratchet mechanism includes a first member 21D with a curved and smooth surface 211D. A spring member 23D is connected between the first and second members 21D, 22D. The second head 15D includes a second through hole 16D defined therein and a second recess 17D is defined in an inner periphery of the second through hole 16D. A driving member 4 is rotatably received in the second through hole 16D and retained by engaging a second C-shaped clip 42 with the second head 15D. The driving member 4 has third teeth 41 defined in an outer periphery thereof and a ratchet mechanism 5 is received in the second recess 17D. The ratchet mechanism 5 has a third member 51 with a second curved and smooth surface 511 facing the driving member 4, a fourth member 52 with fourth teeth 521, and a spring member 53 which is a compression spring and connected between the third and fourth members 51, 52. The fourth teeth 521 are engaged with the third teeth 41. The third member 51 has a third protrusion 512 and the fourth member 52 has a fourth protrusion 522, and two ends of the spring member 53 are engaged with the third and fourth protrusions 512, 522. The user can use the two ratchet mechanisms in the two heads 12D. 15D to output torque in different directions.

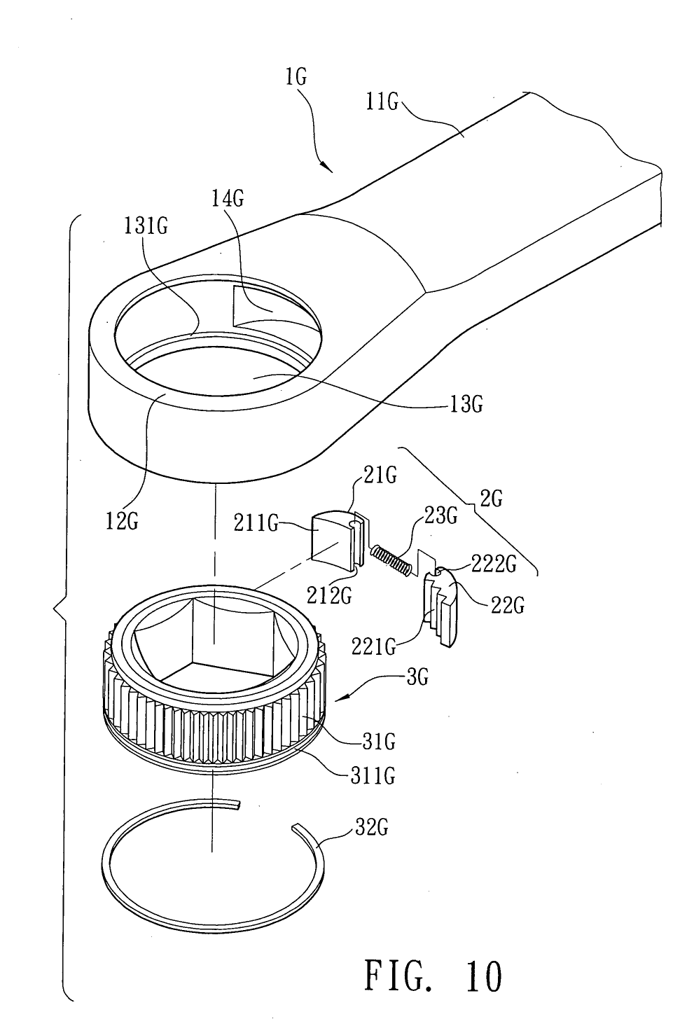

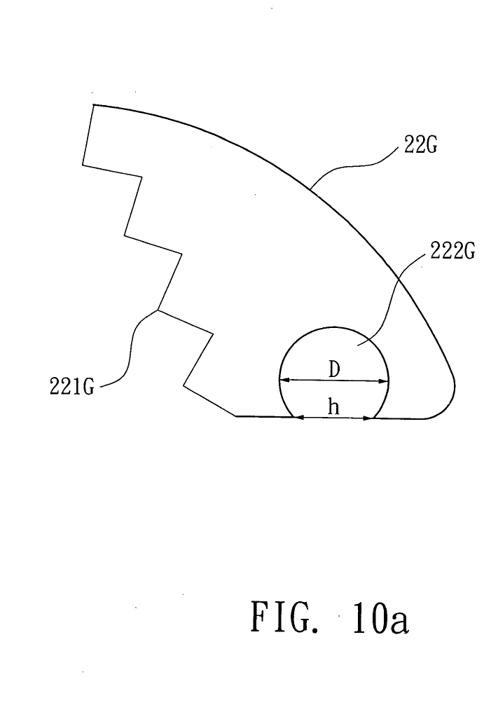

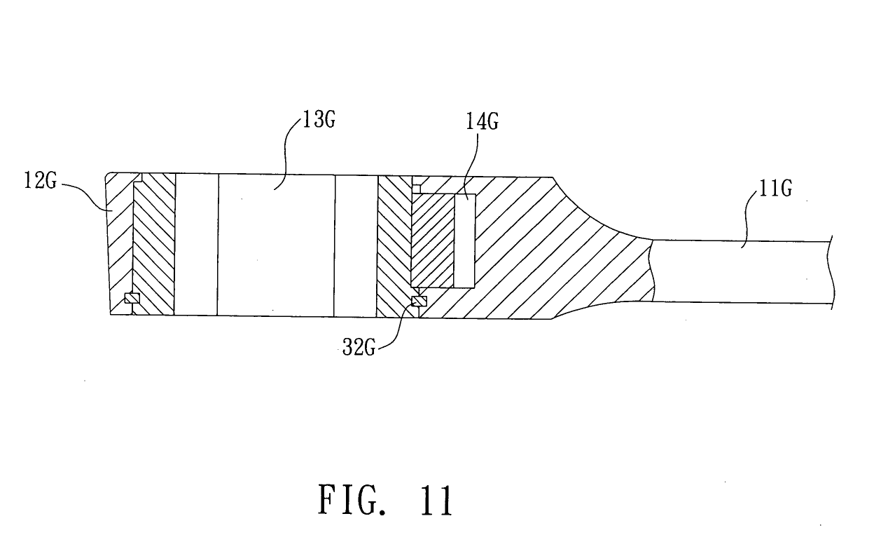

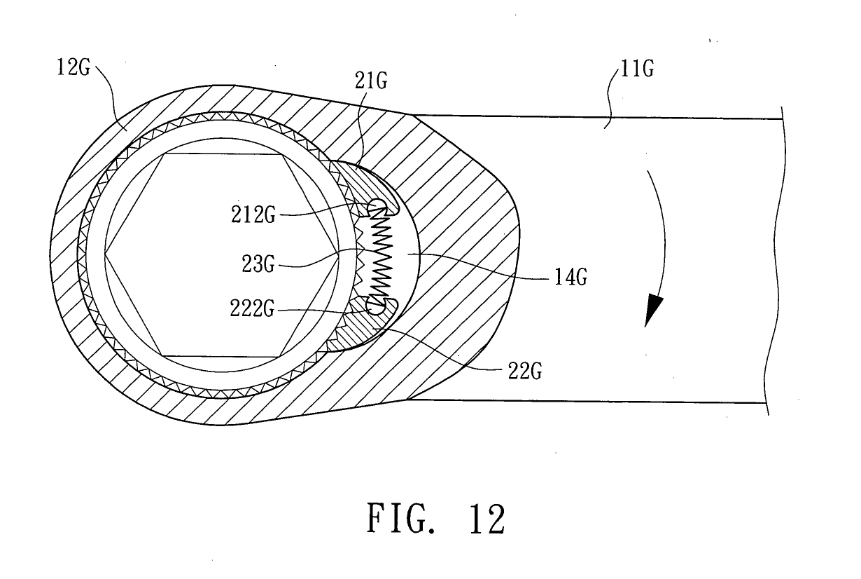

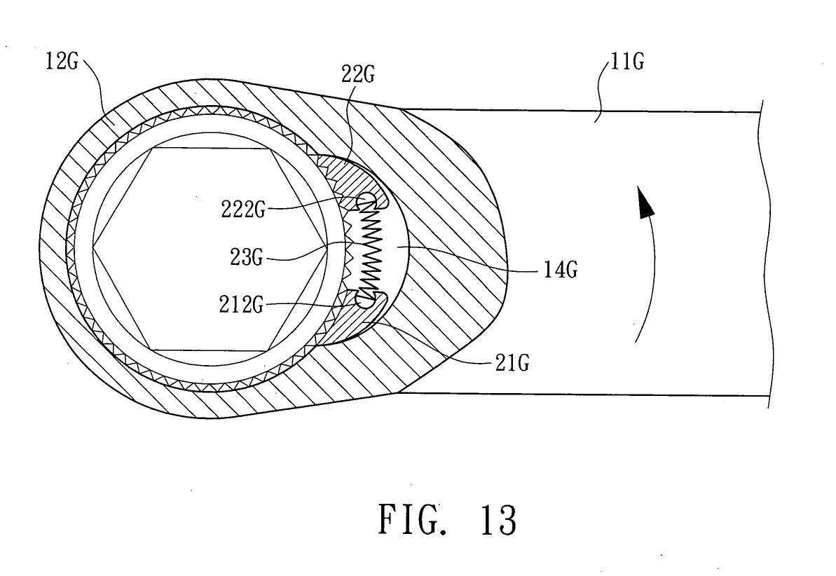

Referring to FIGS. 10, 10a, 11, 12 and 13, the ratchet hand tool 1G of the present invention comprises a handle 11G and a head 12G is connected to an end of the handle 11G. A through hole 13G is defined in the head 12G and a recess 14G is defined in an inner periphery of the through hole 13G. A driving member 3G with first teeth 31G defined in an outer periphery thereof is rotatably received in the through hole 13G and retained by engaging a C-shaped clip 32G with a groove 131G in the inner periphery of the through hole 13G of the head 12G and another groove 311G defined in the outer periphery of the driving member 3G. A third embodiment of the ratchet mechanism 2G of the ratchet hand tool 1G of the present invention is received in the recess 14G and has a first member 21G with a curved and smooth surface 211G facing the driving member 3G, a second member 22G with second teeth 221G, and a spring member 23G connected between the first and second members 21G, 22G. The second teeth 221G are engaged with the first teeth 31G so that when rotating the handle 11G as shown in FIGS. 12 and 13, the driving member 3G is rotated with the rotation of the handle 11G The first member 21G has a first notch 212G defined in an end thereof and the second member 22G has a second notch 222G defined in an end thereof. Two ends of the spring member 23G are engaged with the first and second notches 212G, 222G. The spring member 23G is a compression spring and the pitch diameter of the spring member 23G is between the inner diameter “D” and the width of the opening “h” of the first and second notches 212G, 222G, such that the two ends of the spring member 23G are retained in the first and second notches 212G, 222G. Preferably, the inner diameter “D” and the width of the opening “h” of the first and second notches 212G, 222G are 1.0 mm and 0.8 mm respectively.

FIG. 12 shows that when rotating the handle 11G clockwise, the second member 22G is moved to contact against the inner periphery of the recess 14G and the second teeth 221G are engaged with the first teeth 31G so that the object engaged with the driving member 3G is tightened or loosened by the torque applied thereto. When applying a torque to loosen or tighten the object, the user may flip the ratchet hand tool 1G and re-engage the driving member 3G to the object as shown in FIG. 13, and rotating the handle 11G counter clockwise to output the torque to the object.

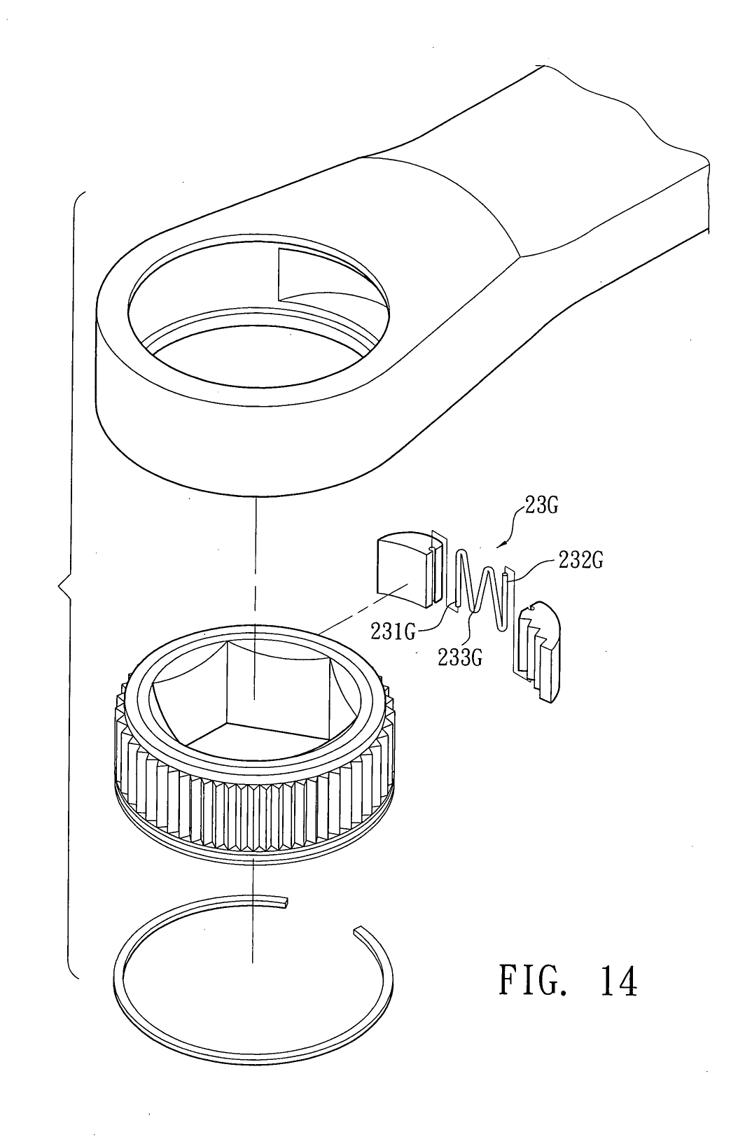

FIG. 14 shows a second embodiment of the spring member 23G of the ratchet mechanism as shown in FIG. 10, wherein the spring member 23G is a serrated-shaped member and composed of an inverted N-shaped portion 233G and two straight portions 231G, 232G are connected to two ends of the inverted N-shaped portion 233G. The straight portion 231G is ended at a lower end thereof and the other straight portion 232G is ended at a top end thereof. The two straight portions 231G, 232G are respectively engaged with the first and second notches of the first and second members respectively.

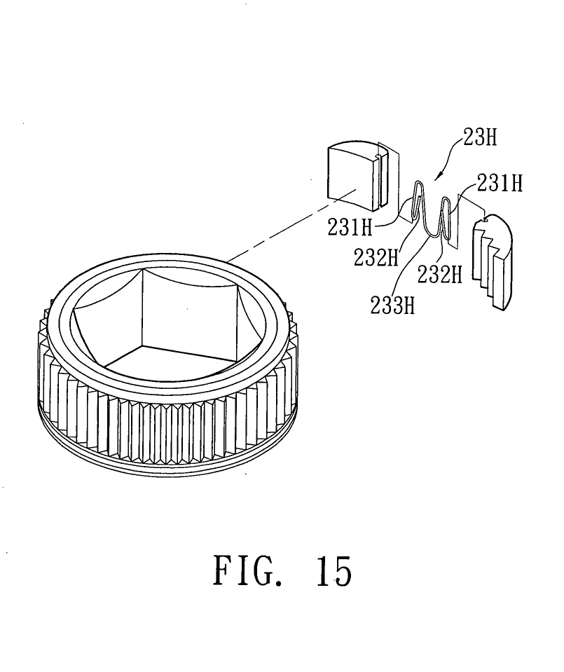

FIG. 15 shows a third embodiment of the spring member 23H of the ratchet mechanism as shown in FIG. 10, wherein the spring member 23H is composed of a substantially U-shaped portion 233H and two downward portions 231H are connected to two ends of the U-shaped portion 233H, each of the two downward portions 231H has an inclined and upward portion 232H extending from a lower end thereof and toward the U-shaped portion 233H. The two downward portions 231H are respectively engaged with the first and second notches of the first and second members respectively.

While we have shown and described the embodiment in accordance with the present invention, it should be clear to those skilled in the art that further embodiments may be made without departing from the scope of the present invention.

What is claimed is:

1. A ratchet hand tool comprising:
a handle and a head connected to an end of the handle, a through hole defined in the head and a recess defined in an inner periphery of the through hole;
a driving member rotatably received in the through hole and retained by engaging a C-shaped clip with the head, the driving member having first teeth defined in an outer periphery thereof, and
a ratchet mechanism received in the recess and having a first member with a curved and smooth surface facing the driving member, a second member with second teeth, and a spring member connected between the first and second members, the second teeth engaged with the first teeth, the first member having a first notch and the second member has a second notch, two ends of the spring member engaged with the first and second notches.

2. The hand tool as claimed in claim 1, wherein the spring member is a compression spring.

3. The hand tool as claimed in claim 1, wherein the two ends of the spring member are two rings.

4. The hand tool as claimed in claim 1, wherein the spring member is an inverted U-shaped member.

5. The hand tool as claimed in claim 1, wherein the spring member is a U-shaped member and the two ends of the spring member are engaged with the first and second notches of the first and second members.

6. The hand tool as claimed in claim 1, wherein the spring member is a p-shaped member and the two ends of the spring member are engaged with the first and second notches of the first and second members.

7. A ratchet hand tool comprising:
a handle and a head connected to an end of the handle, a through hole defined in the head and a recess defined in an inner periphery of the through hole;
a driving member rotatably received in the through hole and retained by engaging a C-shaped clip with the head, the driving member having first teeth defined in an outer periphery thereof, and
a ratchet mechanism received in the recess and having a first member with a curved and smooth surface which faces the driving member, a second member with second teeth, and a spring member connected between the first and second members, the second teeth engaged with the first teeth, the first member having a first protrusion and the second member has a second protrusion, two ends of the spring member engaged with the first and second protrusions.

8. The hand tool as claimed in claim 7, wherein the spring member is a compression spring.

9. The hand tool as claimed in claim 7, wherein the spring member is a spring plate.

10. The hand tool as claimed in claim 7, wherein a second head is connected to the other end of the handle and a second through hole is defined in the second head, a second recess is defined in an inner periphery of the second through hole;
a driving member is rotatably received in the second through hole and retained by engaging a second C-shaped clip with the second head, the driving member has third teeth defined in an outer periphery thereof, and
a ratchet mechanism is received in the second recess and has a third member with a second curved and smooth surface, a fourth member with fourth teeth, and a spring member connected between the third and fourth members, the fourth teeth are engaged with the third teeth, the third member has a third protrusion and the fourth member has a fourth protrusion, two ends of the spring member are engaged with the third and fourth protrusions.

11. The hand tool as claimed in claim 10, wherein the spring member is a compression spring.

12. A ratchet hand tool comprising:
a handle and a head connected to an end of the handle, a through hole defined in the head and a recess defined in an inner periphery of the through hole, a driving member rotatably received in the through hole and first teeth defined in an outer periphery of the driving member which is retained by engaging a C-shaped clip with a groove in the inner periphery of the through hole of the head and another groove defined in the outer periphery of the driving member;
a ratchet mechanism received in the recess and having a first member with a curved and smooth surface facing the driving member and a second member with second teeth, the second teeth removably engaged with the first teeth, the first member having a first notch defined in an end thereof and the second member having a second notch defined in an end thereof, and
a spring member connected between the first and second members. two ends of the spring member being retained within the first and second notches.

13. The hand tool as claimed in claim 12, wherein the spring member is a compression spring and the pitch diameter of the spring member is located between an inner diameter and a width of the opening of the first and second notches.

14. The hand tool as claimed in claim 13, wherein the inner diameter and the width of the opening of the first and second notches are 1.0 mm and 0.8 mm respectively.

15. The hand tool as claimed in claim 12, wherein the spring member is a serrated-shaped member and composed of an inverted N-shaped portion and two straight portions which are connected to two ends of the inverted N-shaped portion.

16. The hand tool as claimed in claim 15, wherein one of the straight portions is ended at a lower end thereof and the other straight portion is ended at a top end thereof.

17. The hand tool as claimed in claim 12, wherein the spring member is composed of a substantially U-shaped portion and two downward portions which are connected to two ends of the U-shaped portion, each of the two downward portions has an inclined and upward portion extending from a lower end thereof and toward the U-shaped portion.
